(19) United States
(12) Patent Application Publication
(10) Pub. No.: US 2008/0184590 A1
(43) Pub. Date: Aug. 7, 2008

(54) PORTABLE COLLAPSIBLE CLOTHES DRYER SYSTEM

(75) Inventor: Juan Jose Campdera Lozano, Barcelona (ES)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Actervis GmbH, Baar/ZUG (CH)

(21) Appl. No.: 11/671,077

(22) Filed: Feb. 5, 2007

(51) Int. Cl. F26B 13/00

(52) U.S. Cl. 34/622

(57) ABSTRACT

A portable collapsible clothes dryer system that includes a flexible collapsible lightweight shell that cooperates with a flexurally resilient frame to define an interior volume into which clothes and other articles to be dried are received. A blower blows air into the interior volume to facilitate drying of the articles. The frame is preferably comprised of flexurally resilient, shape-memory elements that permit the structure to collapse into a compact position for traveling and storage.

### BACKGROUND

The prior art is replete with various types of portable clothes dryers. While each of the prior art portable clothes dryers may serve its intended purpose, a need remains for portable clothes dryer system that is lightweight, yet sturdy, and which can collapse into a compact position for traveling and storage.

### SUMMARY

The present invention is directed to a portable collapsible clothes dryer system that includes a flexible collapsible lightweight shell that cooperates with a flexurally resilient frame to define an interior volume into which clothes and other articles to be dried are received. A blower blows air into the interior volume to facilitate drying of the articles. The frame is preferably comprised of flexurally resilient, shape-memory elements that permit the structure to collapse into a compact position for traveling and storage.

### BRIEF DESCRIPTION OF THE DRAWINGS

FIG. 1 is a perspective view of an embodiment of a portable clothes dryer system in accordance with the present invention shown in the expanded clothes drying or working position.

FIG. 2 is a perspective view of the portable clothes dryer system of FIG. 1 shown in a compact storage position.

FIG. 3 is a perspective view of the portable clothes dryer system of FIG. 1 showing a preferred embodiment of the frame in the expanded position with the shell shown in phantom lines for clarity.

FIG. 4 is a perspective view of the frame and shell of FIG. 3 collapsed into a flat storage position.

FIGS. 5 and 6 illustrate one example of how the frame and shell structure may be further collapsed from the flat storage position illustrated in FIG. 4 to a more compact storage position as illustrated in FIG. 2.

### DETAILED DESCRIPTION

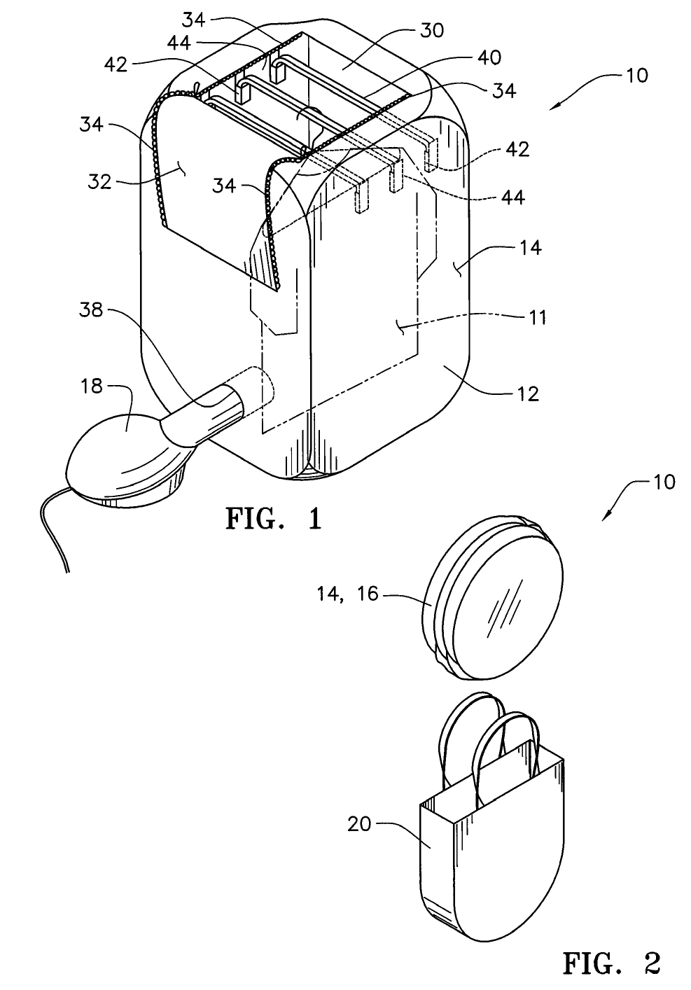

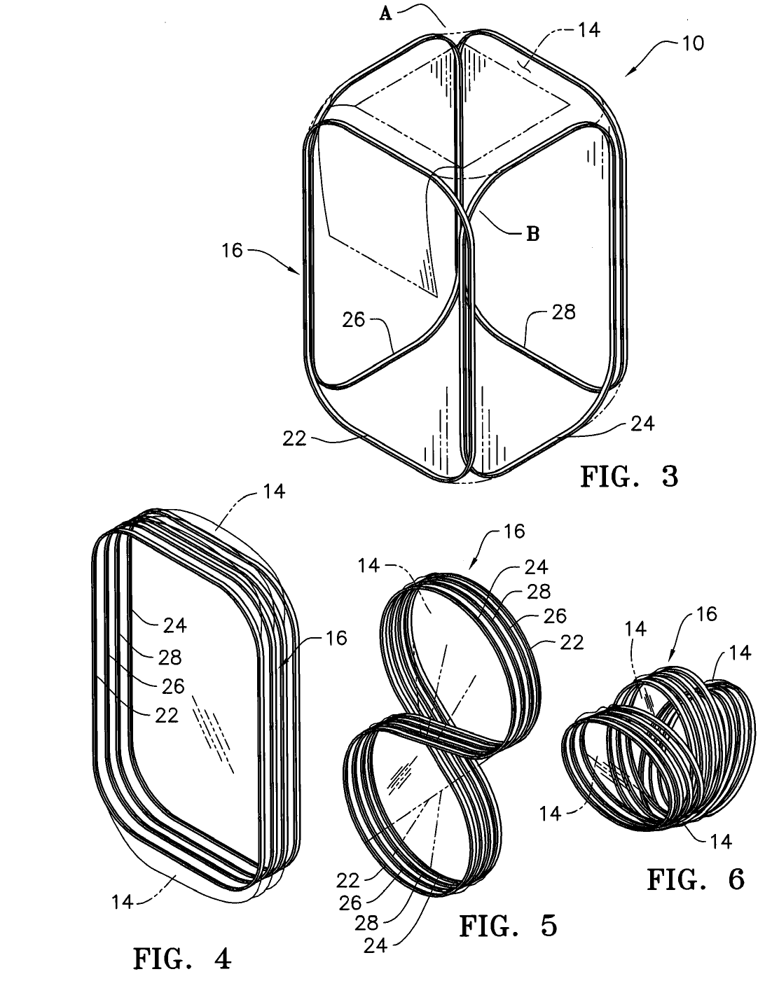

Referring now to the drawings wherein like reference numerals designate identical or corresponding parts throughout the several views, FIG. 1 illustrates one embodiment of a portable collapsible clothes dryer system 10 of the present invention shown in an expanded clothes drying or working position wherein clothing 11 or other articles to be dried are hung or suspended within an interior volume 12 defined by a flexible collapsible shell 14 and a flexurally resilient, collapsible frame 16 (FIG. 3). A blower 18 is provided to blow air into the interior volume 12 to facilitate drying of the articles within.

FIG. 2 illustrates the frame and shell structure collapsed into a preferred compact storage position. A bag or carrying case 20 is preferably provided into which the collapsed structure may be inserted for storage and transportation. Furthermore, as will be discussed in detail later, because the flexurally resilient, collapsible frame 16 preferably comprises a plurality of shape memory elements 22, 24, 26, 28 which are biased in a normally expanded position as best illustrated in FIG. 3, the bag 20 serves to maintain the normally expanded resilient frame elements 22, 24, 26, 28 in the compact storage position.

The shell 14 is preferably comprised of nylon or other light-weight, yet sturdy, material that is quick to dry and is easily collapsible such that it will lay substantially flat. The shell preferably includes an opening 30 of a suitable size for inserting the clothing or other articles to be hung or suspended within the interior volume 12 of the expanded structure. A flap or cover 32 is preferably provided to substantially cover the opening 30. Zippers or other suitable fastening or closing means 34, such as Velcro®, snaps, etc. are provided to fasten or secure the cover 32 over the opening 30. In the preferred embodiment, the fastening means 34 preferably extends around only a portion of the opening 30 such that a gap will remain for air to escape from the interior volume 12 thus facilitating air circulation and speeding the drying of the articles within.

The blower 18 is preferably removably attached to the shell 14 through a port or sleeve 38 through which air is communicated into the interior volume 12 of the expanded structure. The blower 18 may be any suitable apparatus that is capable of imparting air movement and may be powered by any conventional or available power source. The blower 18 may further incorporate a heating element to heat the air to further facilitate more rapid drying of the articles within the interior volume 12.

As best illustrated in FIG. 3, and as previously identified, the flexurally resilient collapsible frame 16 preferably comprises a plurality of shape memory elements 22, 24, 26, 28 that are biased in a normally expanded position. In the preferred embodiment these shape memory elements 22, 24, 26, 28 are preferably rectangular shaped hoops that define the preferred substantially vertical, upright wall panels of the structure. It should be appreciated that although the preferred frame 16 is illustrated as comprising four rectangular hoop elements, an equally suitable structure may be formed from three or more elements of any desired polygonal shape. As illustrated in FIG. 3, the preferred hoop elements are also preferably rectangular in cross section. The preferred rectangular cross-sectional configuration of the shape-memory hoop elements facilitates the biasing of the hoop elements in their preferred normally expanded position. However, other cross-sectional shapes may be equally suitable for the shape memory elements. The preferred hoop elements may be constructed from steel, plastic, composites or any other suitable flexurally resilient material.

Referring now to FIGS. 3-6, in the preferred embodiment, the structure of the clothes dryer system 10 may be collapsed to a flat position as illustrated in FIG. 4 by pushing one corner (“A”) of the frame 16 inward toward an opposite diagonal corner (“B”), for example, thereby causing the hoop elements 22, 24, 26, 28 to fold in on one another into stack, with the flexible shell 14 collapsed between adjacently stacked elements. The structure may be stored in this flat position, if desired, but preferably, the structure is further collapsible into a more compact storage position as illustrated in FIG. 2.

To further collapse the structure from the flat position (FIG. 4) to the more compact position (FIG. 2), opposing sides of the stacked hoop elements are grasped and twisted in opposite directions to form a figure-8 as illustrated in FIG. 5. Next, by continuing to twist the hoops while bringing the ends of the figure-8 together, the hoops will continue to flex and will eventually form a nest of three interconnected coil sets as illustrated in FIG. 6, with the shell 14 collapsed and twisted between adjacent stacked coils.

It should be appreciated that because the preferred frame is comprised of a plurality of shape memory hoop elements 22, 24, 26, 28, each of which is biased in a normally expanded position, if the force used to coil the frame and shell structure into the compact position of FIG. 6 is released, the hoop elements 22, 24, 26, 28 will spring-back to their normally expanded rectangular hoop position as illustrated in FIG. 4. Thus, as previously identified, to maintain the frame and shell structure in the preferred coiled compact storage position, a bag or carrying case 20 is provided in which the coiled structure is inserted.

It should be appreciated that various shapes and arrangements of shape memory frame elements may be provided, each of which may be flexed, twisted or otherwise manipulated into compact storage positions wherein the exterior periphery of the structure while in the compact storage position is less than the exterior periphery of any dimension of the frame structure when in its normally expanded position.

Referring again to FIG. 1, a plurality of substantially rigid struts 40 are preferably provided from which clothes hangers or other article drying accessories may be hung or supported. In a preferred embodiment, the ends of the struts 40 are received within pockets 42 sewn or otherwise secured to opposing interior walls 44 of the shell 14. Alternatively, rather than supporting the struts 40 by the walls of the shell 14, the struts 40 may be supported or hung directly from the frame 16 or intermediate structure (not shown) may be suspended from the frame for supporting the struts 40. In still another alternative embodiment, the clothes dryer system 10 may include a self supporting stand (not shown) disposable within the interior volume 12 of the expanded shell and frame structure.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A portable collapsible clothes dryer system, comprising:
a blower for blowing air;
a flexible collapsible shell;
a flexurally resilient frame cooperating with said shell to define an interior volume, said flexurally resilient frame comprising a plurality of collapsible elements biased in a normally expanded position;
an opening in said shell through which articles to be dried are receivable within said interior volume;
a port in said shell through which air is blown into said interior volume.

2. The portable collapsible clothes dryer system from claim 1 wherein said shell and flexurally resilient frame is collapsible from a flat collapsed position into a more compact storage position having an outer periphery less than an outer peripheral dimension of said frame when in said flat collapsed position.

3. The portable collapsible clothes dryer system of claim 1 comprising at least three collapsible elements.

4. The portable collapsible clothes dryer system of claim 3 wherein said collapsible elements are hoops.

5. The portable collapsible clothes dryer system of claim 4 wherein said hoops are substantially rectangular, rounded corner, hoops.

6. The portable collapsible clothes dryer system of claim 3 further including struts operably supportable within said interior volume from which articles to be dried are supportable.

7. The portable collapsible clothes dryer system of claim 6 wherein said struts are supported from opposing walls of said shell.

8. The portable collapsible clothes dryer system of claim 6 further including a cover sized to substantially cover said opening.

9. The portable collapsible clothes dryer system of claim 8 further including fastening means to fasten said cover over said opening yet maintaining a gap between said opening and said cover to permit air to escape from said interior volume.
